(19) United States
(12) Patent Application Publication
(10) Pub. No.: US 2006/0152343 A1
(43) Pub. Date: Jul. 13, 2006

(54) Patient's signal from dental patient chair

(76) Inventors: Hoang Van Nguyen, San Jose, CA (US); Ngoc Anh Mai, San Jose, CA (US); Hoang Huy Nguyen, San Jose, CA (US); Linh Thuy Nguyen, San Jose, CA (US)

Correspondence Address: HOANG VAN NGUYEN, 277 STAPLES AVE, SAN JOSE, CA, 95127, US

(21) Appl. No.: 11/000,826

(22) Filed: Dec. 1, 2004

(51) Int. Cl. G08B 5/22

(52) U.S. Cl. 340/286.07

(57) ABSTRACT

Light or sound is to be use as a signal from patients to tell dentists or dentist assistants to temporary stop the procedure for communication. Signal device consist of light or sound, and a switch, patients can use their fingers or thumb to turn on the signal switch when in need of communication.

### BACKGROUND OF THE INVENTION

The invention relates to a dental patient chair and, more particularly, a chair having a signal switch.

With traditional dental patient chairs, dentist and dentist assistant focus most of their attention on the procedure and the patient's mouth without knowing much about their patient overall comfort. Patient may feel pretty painful or even in desperate need of using the restroom, but is reluctant to talk knowing a number of tools is in their mouths.

Without an easy way to communication during the procedure, dentist or dentist assistants have to stop the procedure frequently to ask if their patients are in pain. Dentists concern for their patients' comfort causes distractions from their work.

There is a need therefore, to provide a signal switch so that patients can feel more comfortable in communicating their needs and dentists or dentist assistants can focus all their attention on the procedure without having to worry too much about their patients' comfort.

### BRIEF SUMMARY OF THE INVENTION

The object of the invention is to provide a dental patient chair with a switch. The purpose of a switch is to turn on signal using light or sound so patients can give signals to dentist. After receiving the signal, dentists will temporary stop the procedure for patient to communicate their needs.

The significant advantage of the design of the invention is that dentists will be able to focus more on their work without having to worry about their patients' comfort. On the other hand, patients will feel more comfortable in expressing or communicating their needs.

### BRIEF DESCRIPTION OF THE DRAWINGS

FIG. 1 is a dental patient chair having a “patient's signal from dental patient chair” with a switch 1 on the top of the arm rest and is signal through light or sound mechanism 2 which is attached on the headrest of patient chair.

FIG. 2 is a dental patient chair having a “patient's signal from dental patient chair” with a switch 1 on the side of the arm rest and is signals through light or sound mechanism 2 which is attached on the headrest of patient chair.

FIG. 3 is a dental patient chair having a “patient's signal from dental patient chair” with a switch 1 on the top of the arm rest and is signal through light or sound mechanism 2 which is attached on the bracket of the operating light.

FIG. 4 is a dental patient chair having a “patient's signal from dental patient chair” with a switch 1 on the side of the arm rest and is signal through light or sound mechanism 2 which is attached on the bracket of the operating light.

### DETAILED DESCRIPTION OF THE INVENTION

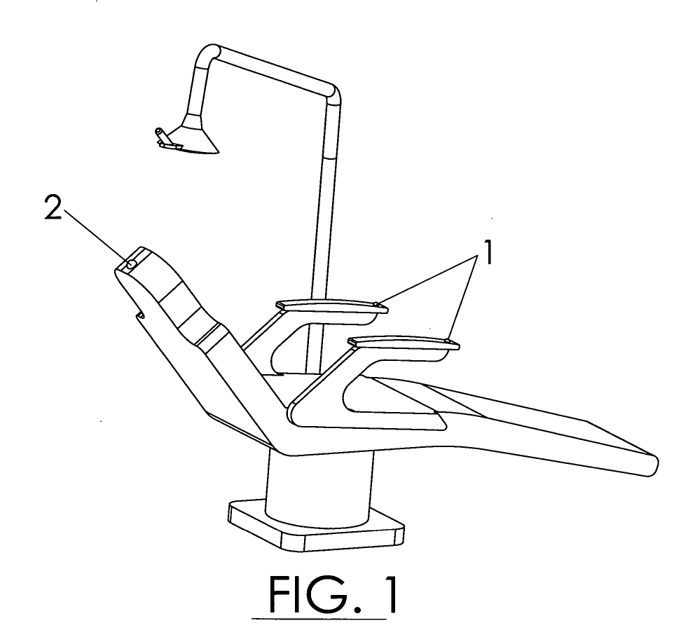

FIG. 1 shows a dental patient chair with a switch signal. The switch 1 is mounted on the top of patient chair armrest. This switch could be a normal electric switch or a toggle switch. Light or sound device 2 is mounted on the headrest of patient chair, where it can easily gives signal to dentist. Light can be a red, yellow or green blinking clamp. Sound device can be any sound or music that is audible to give signal to dentist. Said switch is connected with electric wire to said light or sound device and is connected to electric power source.

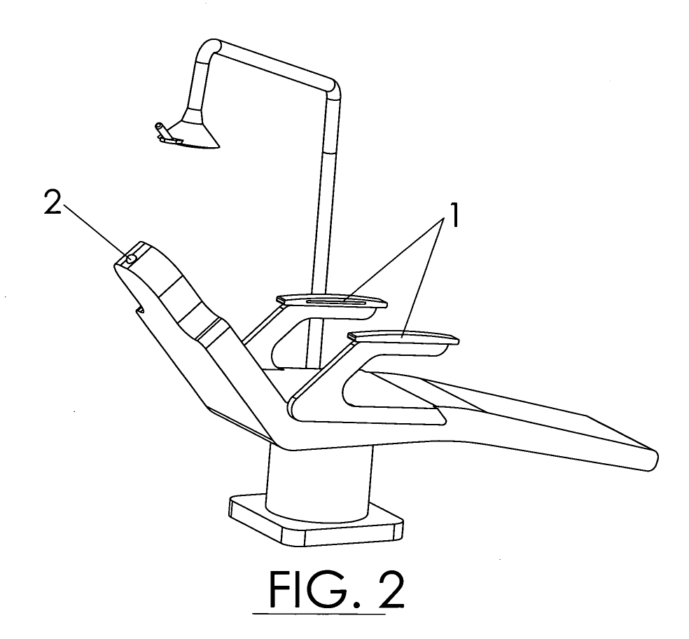

FIG. 2 shows a dental patient chair with a switch signal. The switch 1 is mounted on the side of patient chair armrest. This switch could be a normal electric switch or a toggle switch. Light or sound device 2 is mounted on the headrest of patient chair, where it can easily gives signal to dentist. Light can be a red, yellow or green blinking clamp. Sound device can be any sound or music that is audible to give signal to dentist. Said switch is connected with electric wire to said light or sound device and is connected to electric power source.

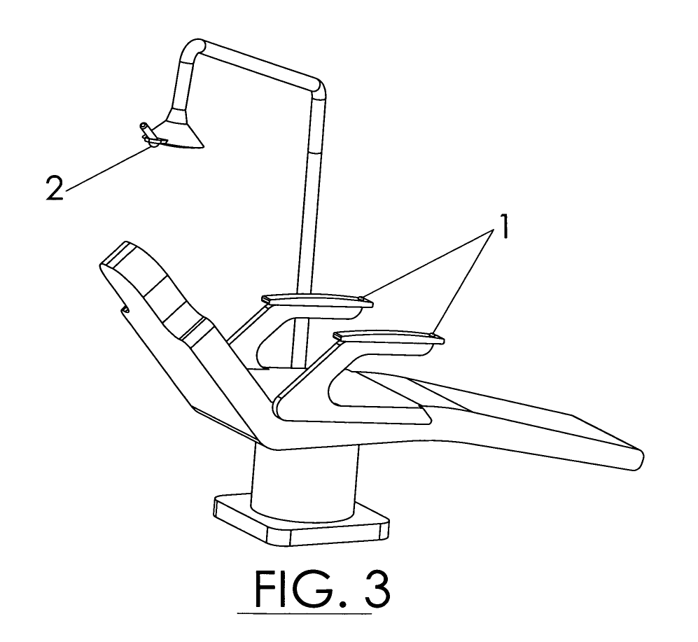

FIG. 3 shows a dental patient chair with a switch signal. The switch 1 is mounted on the top of patient chair armrest. This switch could be a normal electric switch or a toggle switch. Light or sound device 2 is mounted on bracket of the operating light, where it can easily gives signal to dentist. Light can be a red, yellow or green blinking clamp. Sound device can be any sound or music that is audible to give signal to dentist. Said switch is connected with electric wire to said light or sound device and is connected to electric power source.

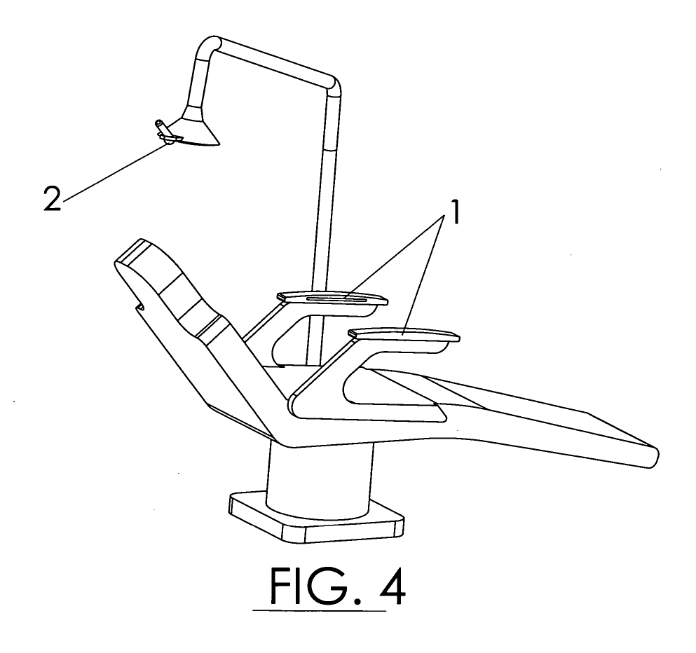

FIG. 4 shows a dental patient chair with a switch signal. The switch 1 is mounted on the side of patient chair armrest. This switch could be a normal electric switch or a toggle switch. Light or sound device 2 is mounted on bracket of the operating light, where it can easily gives signal to dentist. Light can be a red, yellow or green blinking clamp. Sound device can be any sound or music that is audible to give signal to dentist. Said switch is connected with electric wire to said light or sound device and is connected to electric power source.

What we claim as our invention is:

1. A patient's signal from dental patient chair, comprising:
a switch on the dental patient chair, where patient hand can reach;
a light or sound device on the dental patient chair, where it can signal dentist or assistant, connect to said switch and connect to a power source.

2. The patient's signal from dental patient chair according to claim 1, wherein the switch is mounted on a patient chair armrest, where patient can use finger to turn on and off.

3. The patient's signal from dental patient chair according to claim 1, wherein the switch is mounted on a side of patient chair arm rest, where patient can use thumb to turn on and off.

4. The patient's signal from dental patient chair according to claim 1, wherein the light or sound device is mounted on a headrest of patient chair.

5. The patient's signal from dental patient chair according to claim 1, wherein the light or sound device is mounted on a bracket of operating light.

6. A patient's signal to dentists or dentist assistants, comprising:
a switch, where patient hand can reach;
a light or sound that is visible or audible to dentists or dentist assistant.
